(19) United States
(12) Patent Application Publication
(10) Pub. No.: US 2006/0279642 A1
(43) Pub. Date: Dec. 14, 2006

(54) Electronic still camera

(75) Inventor: Tadaaki Yoneda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA CORPORATION

(21) Appl. No.: 11/445,200

(22) Filed: Jun. 2, 2006

Related U.S. Application Data
(63) Continuation of application No. 10/080,589, filed on Feb. 25, 2002.

(30) Foreign Application Priority Data
Mar. 6, 2001 (JP) 061870/2001

(51) Int. Cl. H04N 5/76

(52) U.S. Cl. 348/231.1

(57) ABSTRACT

There is described an electronic still camera for converting captured optical images into electric image signals. The electronic still camera includes a memory to store an image data set of a captured image and a photographing data set including a date-and-time of either capturing the image or storing the image data set; a detector to detect a residual storing capacity of the memory; and an eraser to remove an unnecessary image data set. When a plurality of image data sets are stored in the memory and the residual storing capacity of the memory decreases at a level lower than a predetermined value, the unnecessary image data set is selected, based on dates-and-times included in photographing data sets each of which corresponds to each of the plurality of image data sets, so that the eraser removes the unnecessary image data set from the memory.

This is a continuation application of application Ser. No. 10/080,589, filed on Feb. 25, 2002, which is based on Japanese Application No. 2001-061870, filed on Mar. 6, 2001, both of which are incorporated herein by reference.

### BACKGROUND OF THE INVENTION

The present invention relates to an electronic still camera for converting captured optical images into electric image signals and obtaining image data.

Electronic still cameras such as digital still cameras have been prevailing, which are built to take an optical image from a subject, convert it into an electronic image signal by image pickup device and storing the electronic image signal in external memory.

Recently, various improvements in semiconductor technology have carried out semiconductor memory devices with higher storage capacitance available at lower prices. Particularly, technical innovations in the field of flash memory are remarkable. It is said that in a few years, consumer electric products will incorporate memory devices with some hundred megabytes. Contrarily, number of pixels in recent electronic still cameras have been already so increased to provide enough resolutions for L- or A6-size image printing and there have been less demand to increase pixels furthermore.

When the storage capacity of memory devices is increased, a new utilization of using image pickup units is considerable, that is, using a camera to store a lot of pictures in it, to use them as a photo album, and to transfer pictures directly to and from other cameras or other products (as a telecommunication tool) although a current camera has a relatively small storage space and must save image data to a hard disk of a personal computer or an optical disk (CD-ROM, CD-R/W, etc.) each time the storage space becomes full.

Further, according to further improvement of image compression technique, cameras may be able to store a large quantity of image data (e.g., some thousand picture frames) in its built-in memory. In such a case, it is much complicated and very time-consuming to select and remove unnecessary pictures from a large number of saved pictures. In extreme cases, a function to select and remove unnecessary pictures may not be almost switchable for such utilization.

Furthermore many of, the recent electronic still cameras have been employing flash memory for control program memory to expand camera functions and shorten the cycle of camera development. If they contain an external memory card function inside, they must have additionally a similar memory device other than the control program memory. This is not economical.

The present invention is provided to solve such a problem. In other words, one of the above problems is that it is much complicated and very time-consuming to select and remove less important pictures from a large number of saved pictures by any conventional image erasing and reconfirming method, keeping necessary pictures while image memory devices get less expensive with large storage capacity. Another problem is that a camera must contain two or more similar image memory devices when external image memory function is incorporated inside. This is not economical and interferes compact design of the camera.

### SUMMARY OF THE INVENTION

To overcome the abovementioned drawbacks in conventional electronic still cameras, it is a first object of the present invention to provide an electronic still camera, which is convenient for the photographer to capture images even when the capacity of image memory is increased. Further, it is a second object of the present invention to provide an inexpensive electronic still camera, which realizes both compact body and less power consumption.

Accordingly, to overcome the cited shortcomings, the abovementioned objects of the present invention can be attained by electronic still cameras described as follow.

(1) An electronic still camera comprising: a memory to store an image data set of the object image and a photographing data set including a date-and-time of either capturing the image or storing the image data set, the image data set corresponding to the photographing data set in the memory; a detector to detect remaining capacity for storing image data set in the memory; and an eraser to remove an unnecessary image data set stored in the memory; wherein, when a plurality of image data sets are stored in the memory and the remaining capacity of the memory, detected by the detector, is at a level lower than a predetermined value, the unnecessary image data set is selected out of the plurality of image data sets, based on dates-and-times included in photographing data sets each of which corresponds to each of the plurality of image data sets, so that the eraser removes the unnecessary image data set from the memory.

For example, if memory with a large storage capacity has image data of a great number of picture frames (a lot of image data), image data of picture frames that have been stored longest in memory (having oldest shooting or saving dates) may never or rarely be used any more. This is because even the user may not remember shooting them. It is possible to used it as new available storage spaces by automatically removing such old image data.

It is acceptable to removes image data of the oldest shooting or saving time/date. This is because the frequently-used pieces of image data with the oldest shooting or saving data may be already loaded and processed in a personal computer if they are ready important ones.

Further, when a means is provided to count how often image data is read from memory, the erasing means and the counting means can work together to remove only image data that has the oldest shooting or saving time/date and the least count. (The favorite image data of the oldest shooting or saving time/date usually tends to have a relatively-large number of count.) This can make the user free from the complicated time-consuming work for selecting and removing less important image data. Image data with the oldest shooting or saving time/date and the least count is automatically removed and consequently new memory space is available for additional image data, according to necessity.

Furthermore, with a mode for prohibiting the erasing means from removal, necessary image data can be protected against automatic deletion. Here, a shooting time/date is a time/date at which a picture (data) was taken and a saving time/date is a time/date at which a picture (data) was saved in memory. A time/date can be solely a date.

(2) An electronic still camera comprising: an imager that converts an object image into electronic signals, so as to generate an image data set; a controller that controls at least the imager, so as to conduct controlling actions for a photographing operation; and a memory that includes at least a first storing region, which provides a program memory section for storing a processing program to conduct the controlling actions for the photographing operation, and a second storing region, which provides an image memory section for storing the image data set as an image file; wherein, even if either the first storing region or the second storing region is in process of a writing or erasing operation of data stored therein, a readout operation for another one of them can be simultaneously performed, and the controller reads out the processing program to execute it.

(3) An electronic still camera an object comprising: an imager that converts image into electronic signals, so as to generate an image data set from the electronic signals; a controller that controls at least the imager, so as to conduct controlling actions for a photographing operation; and a memory that includes at least a first storing region, which provides a program memory section for storing a processing program to conduct the controlling actions for the photographing operation, and a second storing region, which provides a camera adjusting-data memory section for storing camera adjusting-data to compensate for a difference between cameras; wherein, even if either the first storing region or the second storing region is in process of a writing or erasing operation of data stored therein, a readout operation for another one of them can be simultaneously performed, and the controller reads out the processing program to execute it.

(4) An electronic still camera comprising: an imager that converts an object image into electronic signals, so as to generate an image data set from the electronic signals; and a memory that includes at least a first storing region and a second storing region; wherein, even if either the first storing region or the second storing region is in process of a writing or erasing operation of data stored therein, a readout operation for another one of them can be simultaneously performed, and the first storing region includes at least two rewritable storing sections, one of which is a camera adjusting-data memory section for storing camera adjusting-data to compensate for a difference between cameras, and another of which is an image-data memory section for storing the image data set as an image file.

For example in conventional electronic still cameras, the embodiments of the present invention, cited above in items 2 to 4, use two different memory devices: one for a program memory area and another for an image memory area. This causes a larger print circuit due to mounting space for both memory devices, consequently result into the bigger camera body, also increases the total power consumption of the camera. Contrarily, the present invention can reduce both the volume and the power consumption of the camera. This can be accomplished by a memory device having at least two memory spaces one of which is read while the other is written. One of such memory devices is multi-bank flash memory, but is not to be construed to limit the scope of the invention. Herein, non-volatile memory is preferable.

An electronic still camera can reproduce images on built-in type of a liquid crystal display monitor or an external TV monitor from electric image signals stored in external memory, or can temporarily display image data on a high-resolution monitor of a personal computer by transferring image data from the camera to the personal computer through external interface or memory card.

Recent personal computers have widely employed USB interface for connection with peripherals. The USB interface makes the connection with peripherals much easier than any conventional interfaces. Particularly, many peripherals have been classified and assigned USB device classes, so that standard device drivers have been prepared as pre-installed drivers. Accordingly, there is a tendency to standardize interface protocols into a common interface protocol. However, since it requires so much effort to standardize device drivers that it takes a long time to prepare preinstalled drivers. However, in fact, USB class-drivers have been expanded one by one according to OS revision.

During the period of improvement on standard device driver, even an identical unit is supported by a specific OS but not supported by other OSs, depending upon OS versions. If the unit is not supported by an OS, a proper device driver for controlling the unit must be installed in the OS. This is very inconvenient. Particularly, as most of electronic still cameras are designed for portable usage and a personal computer in the shooting site is not always available, the user must carry it together with, for example, a notebook computer containing the proper device driver for connection with the camera, or together with a storage medium containing software to install the proper device driver.

The above mentioned problem is due to the reason where a camera cannot always be connected to a personal computer in the shooting location during the period of development of a common device driver while standardization of interface protocols is in progress.

To solve this problem, the configuration cited in item 4 of the present invention allows the electronic still camera to be connected to a personal computer even when the personal computer does not have a specific device driver for the camera. To accomplish the above purpose, other image-recording apparatus, embodied in the present invention, will be described as follow:

(5) An electronic still camera having interface which enables the camera to a personal computer, comprising

a first storage area which stores a program to be presented for the personal computer when the camera is connected to the personal computer and

a means which allows the personal computer to recognize the camera as a storage device when the camera is connected to the personal computer and to automatically access the first storage area,

wherein the personal computer loads the program from the first storage area, and can recognize the camera as a unit different from the storage device by running the program.

In accordance with this configuration, single connection of the electronic still camera to the personal computer allows the personal computer to recognize the camera as a storage device, which can read and write data such as a CD-ROM drive or a CD-RW drive, to read a program from the first storage area, to be able to recognize the camera as a device (e.g., the electronic still camera itself different from the storage device, and to automatically perform a series of operations such as image data capturing.

(6) An electronic still camera having interface which enables the camera to an external personal computer, comprising

an operating means performing as at least one storage device that can be recognized by the personal computer when the camera is connected to the personal computer and allowing at least one of the storage device to work as a storage unit having a function that can automatically execute a predetermined operation on the personal computer when the storage device is recognized,

a means for allowing the personal computer to access the first storage area as a data area in the storage unit of the electronic still camera, and

a processing means for allowing the personal computer to access the first storage area, to get data from the area, and to recognize the apparatus as a device which is functionally different from the storage device.

As the above configuration comprises the operating means, the allowing means, and the processing means, simple connection of the electronic still camera to the personal computer allows the personal computer to recognize the camera as a storage device which can read and write data such as CDROM drive or CD-RW drive, to read a program from the first storage area, to recognize the camera as a device (e.g., the electronic still camera itself) different from the storage device, and to automatically perform a series of operations such as image data capturing.

Further, the processing means comprises a means for allowing the personal computer to execute a program stored in the storage area when the personal computer accesses the first storage space and to consequently recognize the apparatus as a device which is functionally different from the storage device. With this, the personal computer can automatically read image data.

Furthermore, when electronic still camera is recognized as a CD-ROM (as the storage unit) by the personal computer, the processing means can make almost every kind of personal computers perform the above operations without changing their setting.

Further, the first storage area is preferably in built-in memory or one of memory cards mounted on the electronic still camera. Further more, the first storage area is preferably a non-volatile memory medium.

Among storage device that can be recognized by the personal computer, a storage device has a function capable of executing a preset operation automatically on the personal computer when the storage unit is recognized by the personal computer. With a means of selectively allowing the personal computer to access the first storage area (as a data area of the storage device) in the electronic still camera, the user may have a choice whether automatic reading by the personal computer is enabled when the electronic still camera is connected to the personal computer. A preset operation here means, for example, installation of a device driver, but is not to be construed to limit the scope of the invention.

When the electronic still camera is connected to and recognized by the personal computer, the device ID code for specifying the storage unit should preferably be different from a device ID code for specifying a device other than the storage device.

With a means for causing the personal computer to select recognition of a storage unit or recognition of a device other than a storage unit, the user may have a choice whether automatic reading by the personal computer when the electronic still camera is connected to the personal computer.

Further, the electronic still camera in accordance with the present invention comprises a means for detecting detachment of camera-PC connection to cause the personal computer (PC) to read data for recognizing a device other than a storage device in the storage device operation, and a means for automatically changing settings so that the camera may act as a device other than the storage unit. With these means, in the case that the electronic still camera is set to work as a unit other than the storage unit, the image data of the electronic still camera can be automatically read by the personal computer when the connection of the electronic still camera to the personal computer is re-established. It is also possible to suppress automatic reading of image data from the electronic still camera when the camera is reconnected to the personal computer.

Further, the electronic still camera comprises a switching means for connecting or disconnecting the interface, a timer means for measuring time computer to load data which causes the personal computer to recognize the electronic still camera as a device other than the storage device, a means for comparing this connection time by a predetermined time period, and a means for automatically changing so that the electronic still camera may work as a device other than the storage device. If the comparing means detects that the connection is continued exceeding the predetermined time period, the changing means automatically breaks the camera-PC connection, changes so that the electronic still camera may work as a device other than the storage device, and the switching means starts to reconnect the electronic still camera to the personal computer. In this configuration, even if any trouble occurs in reconnection or the personal computer cannot read data from the electronic still camera within a pre-determined time period, the electronic still camera in accordance with the present invention is designed to be recognized as a device (e.g. an electronic still camera itself) other than the storage device. Therefore,. a personal computer may read image data from the electronic still camera through a device driver which is already installed in the personal computer.

Further, it is preferable that the electronic still camera is recognized as a still image class device for a device other than the storage device.

### BRIEF DESCRIPTION OF THE DRAWINGS

Other objects and advantages of the present invention will become apparent upon reading the following detailed description and upon reference to the drawings in which:

FIG. 1 is an internal block diagram of an electronic still camera, which is an embodiment of the present invention;

FIG. 2 is a memory mapping of flash ROM of FIG. 1;

FIG. 3 is an example of initial protocol packets (descriptors) used for primary connection of an electronic still camera which is an embodiment of the present invention to a personal computer 20 through an USB interface 10;

FIG. 4 is an example of initial protocol packets (descriptors) used for normal operation of a still image class device;

FIG. 5 shows the content of a directory of files of a storage unit which is detected as CD-ROM device by a personal computer 20;

FIG. 6 shows the content of a sample “autorun.inf” file;

FIG. 7 shows possible combination table of bank operations on multi-bank flash memory which is used by an embodiment of the present invention;

FIG. 8 shows an operational flow of setting the status of the storage device of the present embodiment, enabling installation of a driver for a still image device which works differently from the storage device, detecting interfacing status by cable connection and power setting, and resetting to the original still image device;

FIG. 9 shows an operational flow of the personal computer 20;

FIGS. 10(a) and 10(b) show sample LCD displays of the electronic still camera for setting a mode to install a still image device driver to a personal computer 20;

FIG. 11 is a circuit drawings of the USB interface connector 10 and its related parts;

FIG. 12 is an operational flow of selecting images to be removed when the built-in image memory is full and removing the selected images;

FIG. 13 is a perspective view of an electronic still camera which is an embodiment of the present invention; and

FIG. 14 is a rear view of an electronic still camera which is an embodiment of the present invention.

### DETAILED DESCRIPTION OF THE PREFERRED EMBODIMENT

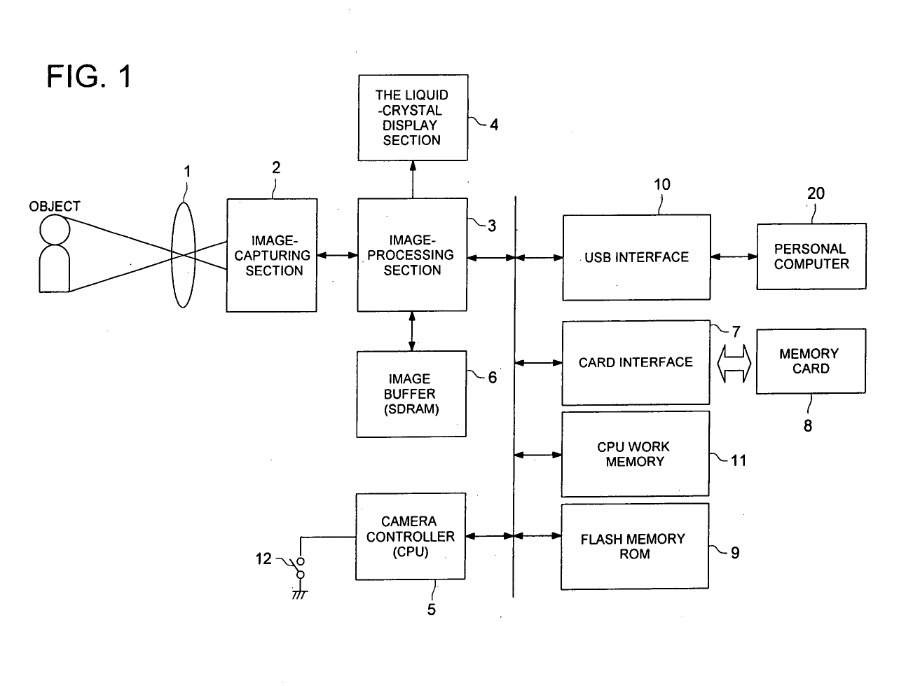

Referring to the drawings an embodiment of the present invention will be detailed in the following. FIG. 1 is an internal block diagram of an electronic still camera which is an embodiment of the present invention. In FIG. 1, the optical system 1 focuses the image of an object on the image pickup device (not shown in the drawings) in the image-capturing section 2. The image-capturing section outputs electric signals from the picked-up image to the image-processing section 3. The image-processing section 3 receives the electric signals, color-process on the signals is performed, and outputs image signals to the liquid-crystal display section 4 to preview the image on the liquid-crystal display section 4 before the release button (not shown in the drawings) is pressed. The liquid-crystal display section 4 displays the inputted image signal on the LCD screen (not shown in the drawings).

When the release button (not shown in the drawings) is pressed, the camera controller 5 comprising a CPU or others detects the operation of the release, and instructs the image-processing section 3 and the image-capturing section 2 to capture a high-resolution image. Upon the instruction, the image-processing section 3 takes the data of the high-resolution raw image, temporarily stores the image in the image buffer 6 which comprises SDRAM or others, performs color-processing and gradation control on the raw image, and displays it as a post-view image on the liquid-crystal display section 4. Images are compressed, for example, in form of the JPEG format and temporarily stored in the image buffer 6.

When the image compression is complete, the image-processing section 3 informs the camera controller 5 of the completion of the image compression. Upon the notification, the camera controller reads the compressed image data from the image buffer 6 through the image-processing section 3 and stores the compressed image data of a preset file format in the memory card 8 through the card interface 7. Or when a command is issued in order of image data recording in internal memory, the camera controller 5 stores image data in flash ROM 9, which also contains a program memory area.

When the electronic still camera is connected to an external personal computer 20 through USB interface 10, the camera controller 5 communicates with the personal computer 20 in a protocol through the USB interface 10. Simultaneously, when a command is issued to read image data from the memory card 8 or write image data in the memory card 8 or to read or write built-in image data, the camera controller 5 controls transfer of data to and from appropriate blocks. The CPU work memory block 11 is a memory block such as SRAM, which can be read-/write-accessed fast.

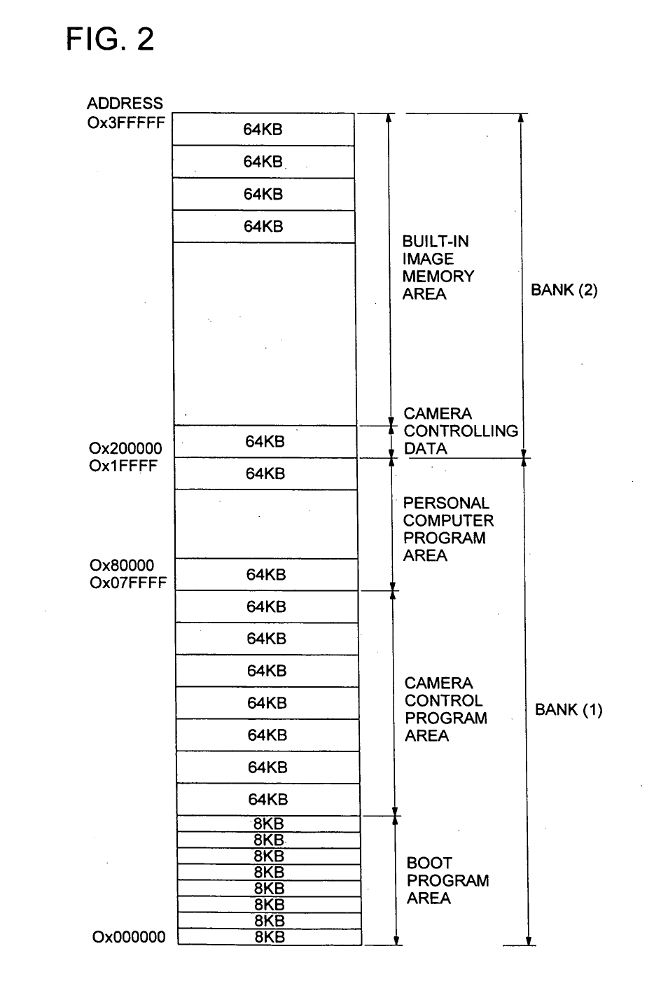

FIG. 2 is a memory mapping of flash ROM of FIG. 1. Conventionally, flash memory (the flash memory block 9 here) takes a lot of time to write or erase. So it is impossible to read from flash memory immediately after data is written there. To rewrite programs, external RAM is provided. The user rewrites programs after locating an executable program on RAM. Recently, some flash memory manufacturers have put, on the market, multi-bank type flash memory chips which allows reading from one memory bank while writing or erasing in another memory bank. Due to this memory technology, it is possible to locate both program code space and a memory space for storage of images and/or camera control values in manufacturing processes in the same memory device.

As an example, functions of a multi-bank flash memory chip, using a 4 MB multi-bank flash memory chip, will be detailed in the following. This example shows that the leading 2M bytes as bank 1 is used to store programs and the trailing 2M bytes as bank 2 is used to store image data and camera control data (in the manufacturing processes). The top eight 8K blocks in bank 1 are assigned a booting program to start up the CPU in the camera controller 5. These blocks are followed by seven 64K blocks (448 KB), which store programs to control the whole electronic still camera.

The trailing twenty-four 64KB blocks (1536 KB) of bank 1 contain programs and kind of scriptors for personal computers to install a specific device driver in the personal computer 20. This storage area for storing scriptors and programs for a personal computer is the first storage area built in the electronic still camera in accordance with the present invention. Storage areas called bank 1 and bank 2 are large rewritable storage units (first and second storage areas) of the present invention and smaller 64- and 8-KB storage blocks are small rewritable storage units. As for large rewritable storage units, one large storage unit can be read while the other large storage unit is written. However, since smaller storage units belong to one large storage unit, one small storage unit cannot be read while another small storage unit is written.

The top eight 64K block in bank 2 stores data (or camera control data) to compensate a product-specific difference in production of the camera such as correction values due to optical characteristics and sensitivity characteristics of the image-capturing section 2 and driving information for automatic focus control. This camera control data area is followed by an internal image memory area. As this example uses built-in flash memory of a limited storage capacitance, the built-in image memory area is not so wide enough. This is because the flash memory technology has just begun. The low storage capacity, however, has nothing with the effect of the present invention. The most important point here is that the boot program area and the camera control program area are provided in a bank which contains neither the image memory area nor the camera control data area. In other words, the boot program area and the camera control program area are required for the CPU in the camera controller 5 to use continuously. If the camera controller 5 cannot read any program code while rewriting image data or camera control data, the electronic still camera may fall into out-of-order condition. Further, another important point is that the camera control data is stored in a block (small storage area) outside the image memory area. Considering about integrity of data, it is recommended to locate these two areas separately in different banks, but it is not economical. For data integrity, it is enough to locate these two areas separately in different banks. With this, the camera control data essential to the electronic still camera can be protected against damages by unexpected operations from the personal computer.

Among USB device classes, human interface devices such as mice and keyboards and mass storage devices have bee standardized from earlier stages and supported by various operating systems up to date. The CD-ROM devices as one of mass storage devices are often used to install software and have been provided of various functions of automatic installation than the other mass storage devices. Particularly, the “autorun” function of the CD-ROM devices is remarkable.

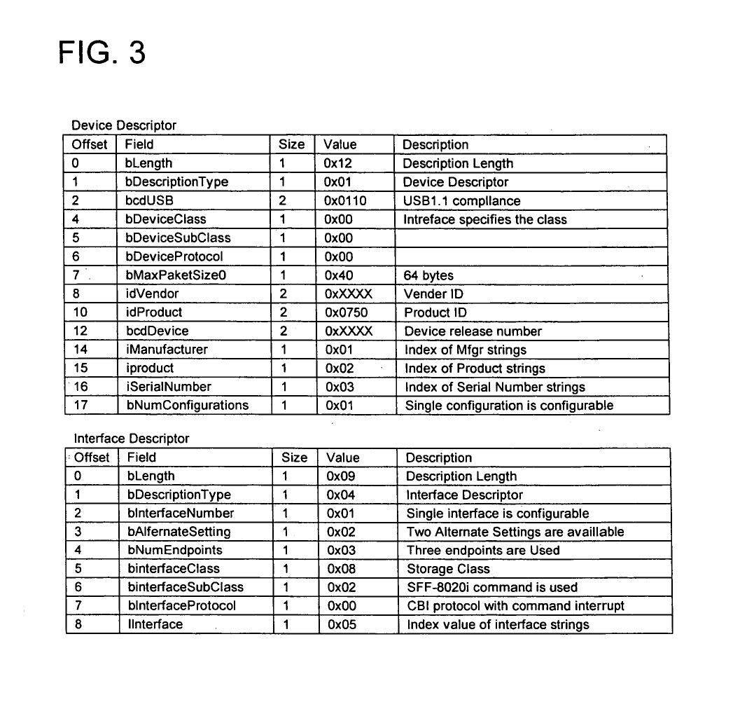

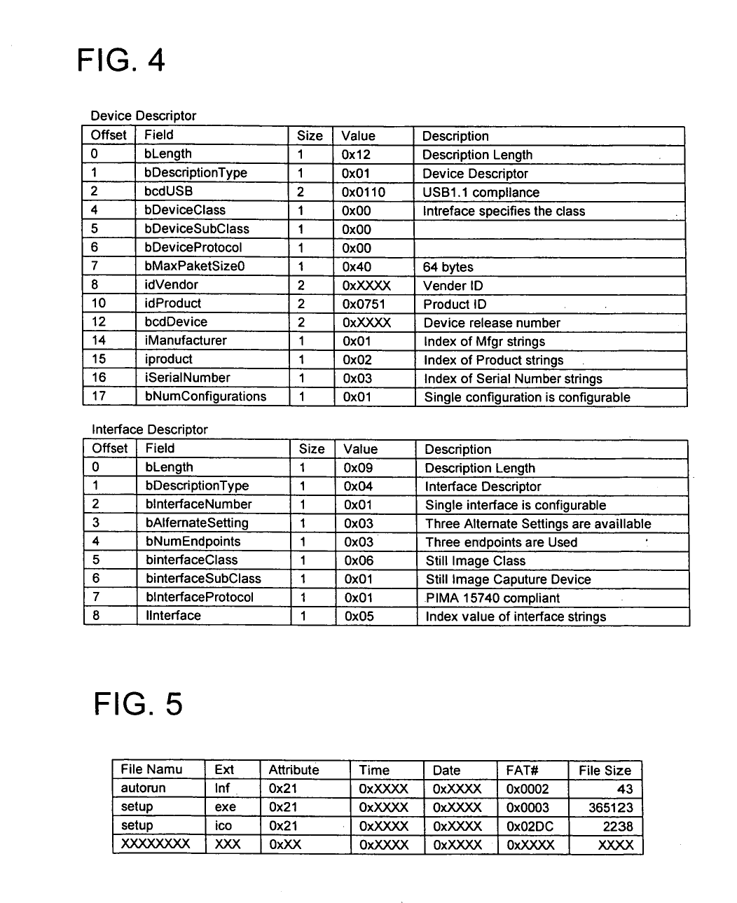

FIG. 3 and FIG. 4 are examples of initial protocols (descriptors) used for connection of an electronic still camera which is an embodiment of the present invention to a personal computer 20 through an USB interface 10. When the electronic still camera is connected to a personal computer 20 through a USB interface block 10, the personal computer 20 issues a Get Descriptor command to the electronic still camera after hardware handshaking. In response of receiving this command, the electronic still camera replies the descriptor to the personal computer.

FIG. 3 shows an example of initial protocol to report that the electronic still camera is a CD-ROM mass storage unit. The detailed explanation of the descriptor is omitted here because people in this field can easily understand the descriptor. Only the striking features of the descriptor are described below. In the device descriptor (the upper table of FIG. 3), Offset 4 declares that the device class of this device will be described with the interface descriptor. Offset 5 and offset 6 specify the required values. Offset 10 specifies “0×0750” as the unique USB product ID given to the electronic still camera by the manufacturer of the product. (The manufacturers also should have their unique USB product IDs.) The ID value is given by “idvendor” of offset 8. When combined with the vendor ID, the product ID becomes more specific and the OS of a personal computer to which the product is connected can easily identify the product by the ID.

The interface descriptor (the lower table of FIG. 3) describes the device class of the product (electronic still camera) according to the content of “bDeviceClass” (Offset 4) of the device descriptor. Offset 5 (blnterfaceClass) specifies “OxO8” as the class code of the storage class and offset 6 (blnterfaceSubClass) specifies that the interface uses the SFF-8020i command set which is widely used by CDROMs. Offset 7 (blnterfaceProtocol) describes that the interface uses the CBI (Control/Bulk/Interrupt transfer) function as the USB mass storage protocol. With this, the SFF-8020i command is executed as a CD-ROM command with the command contained in bulk transfer packets of the USB. In this way, the electronic still camera is recognized as a CDROM device by the personal computer 20.

FIG. 4 is an example of an initial protocol (descriptor) used for initial reconnection of the electronic still camera to the personal computer 20 after the electronic still camera is connected as a CD-ROM drive to the personal computer 20 and loads a still-image class device driver (which is a device class for controlling electronic camera devices) to the personal computer. An operation to cause the electronic still camera as a device other than the storage device in this embodiment is to install a still-image class device driver to a personal computer. As the device descriptor for installation uses a product ID of “0×0750” in primary connection as a CD-ROM drive, the device descriptor for the still-image class operation uses a product ID of “0×075” to prevent confusion. This product ID is a device ID code which is referred to by this embodiment. The interface descriptor (the lower table of FIG. 4) specifies a still-image class in offset 5 (blnterfaceClass), an image pickup device in offset 6 (blnterfaceSubClass), and use of a PMA 15740 command set in offset 7 (blnterfaceProtocol).

As explained above, the sample protocols (descriptors) of FIG. 3 are used to connect the electronic still camera as a CD-ROM drive (a storage device) to a personal computer and to cause the personal computer to recognize the electronic still camera as a device (an electronic still camera) other than the storage device). Therefore, the camera controller 5 is in charge of operation, processing, and selection in accordance with the present invention.

FIG. 5 shows a table of directories of files to be detected by the personal computer when the electronic still camera is connected as a CD-ROM drive (a storage device) to a personal computer. In this example, the personal computer 20 detects an “autorun.inf” file (43 bytes long), a “setup.exe” file (365123 bytes long), and a “setup.ico” file (2238 bytes long). The “autorun.inf” file is a script file for automatic startup. In general, when the operating system (OS) of a personal computer 20 finds this script file in searching of file information in the CD-ROM, the OS automatically performs pre-determined operations according to the description. In other words, this function causes a pre-determined operation to be automatically executed by the personal computer when recognized by the personal computer. The camera controller 5 for detecting and executing this internal file is the means for allowing the personal computer to access the first memory area and the means for causing the personal computer to execute programs in accordance with the present invention.

Although the above example describes an area in the built-in flash memory (flash ROM 9) as the first memory area, it is apparent that the first memory area need not be built-in memory, for example, a memory area in an external memory card 8 as far as the memory area is under control of the CPU in the camera controller 5. In this case, there can be some units (flash memory ROM 9 and memory card 8 here) equivalent to a CD-ROM drive having the “autorun” function. It is possible to use a setup menu of the electronic still camera to select the memory area. When a memory area is selected on the setup menu by an operation button (not shown in the drawings) and a means is used to determine whether the first memory area is accessed by the personal computer, the camera controller 5 is the setting means.

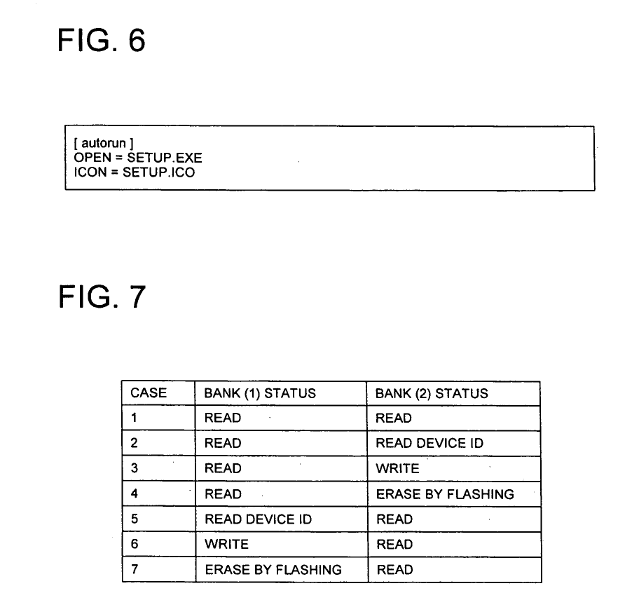

FIG. 6 shows the content of a sample “autorun.inf” file. The “ICON=” line in the “[autorun]” section specifies to use the icon data (SETUP.ICO) as a volume display icon of CD-ROM (flash memory 9 in this example) and the “OPEN=” line specifies to execute the SETUP.EXE file in the root directory of the specified CD-ROM (flash memory 9 in this example).

According to this description, the operating system (OS) of the personal computer 20 runs the SETUP.EXE file, which is the installer of a driver required for operation of the still-image class.

FIG. 7 shows possible combinations of bank operations of multi-bank flash memory which is used by an embodiment of the present invention.

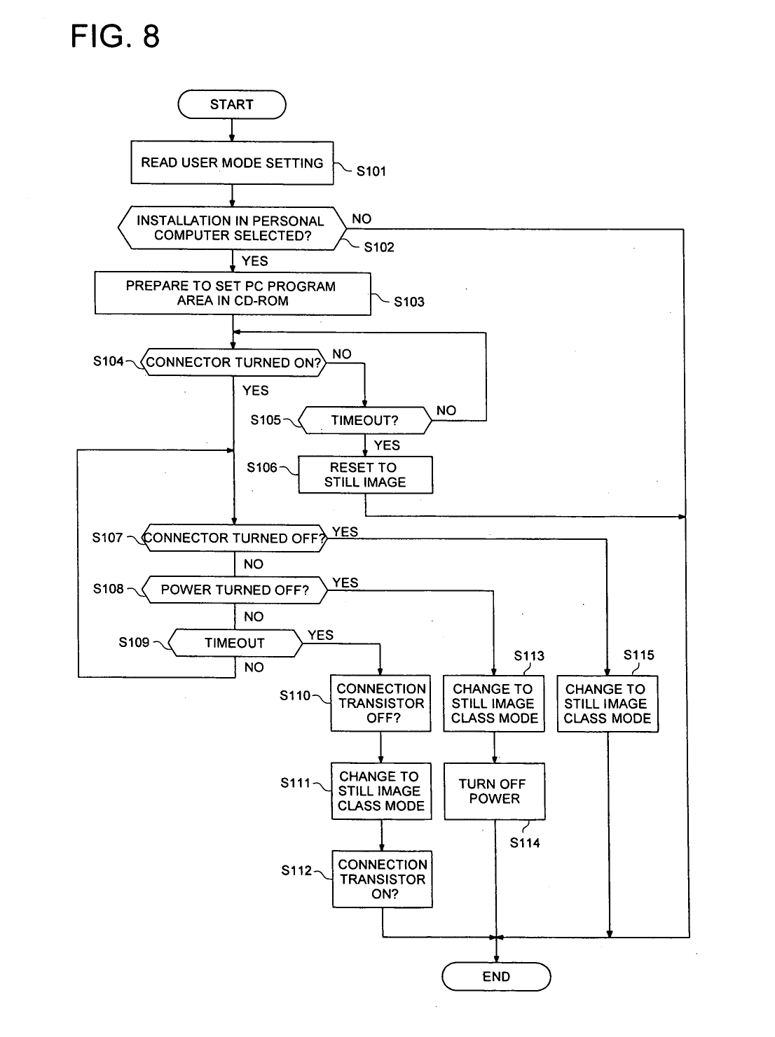

FIG. 8 shows an operational flow of setting the status of the storage unit of the present embodiment, enabling installation of a driver for a still image device which works differently from the storage unit, detecting interfacing status by cable connection and power setting, and resetting to the original still image device.

When the user sets a READ mode at step S101 of FIG. 8, the camera controller 5 checks whether installation to the personal computer 20 has been selected at step S102. If the installation has not been selected, the operation flow ends. When the installation is already selected, the camera controller 5 prepares to cause the personal computer to recognize the program area for the personal computer as CDROM.

At step S104, the camera controller 5 checks whether a signal is detected from a connector (not shown in the drawings), which connects the electronic still camera to the personal computer 20. If no signal is detected, the camera controller 5 waits for a pre-determined time period at step S105, resets to the still-image class, and ends the flow.

When detecting a signal indicating the connection between the electronic still camera and the personal computer from the connector, the camera controller 5 makes sure that the connector is not disconnected at step S107. (If the connector is disconnected, the camera controller 5 changes to the still-image class at step S115 and ends the operation flow.) Further the camera controller 5 makes sure that the power supply has not been turned off at step S108. (If the power supply is turned off, the camera controller 5 changes to the still-image class at step S113 and performs the power-off operation at step S114.) Furthermore, the camera controller 5 checks whether a pre-determined time period has passed at step S109. When the pre-determined time period already passed, the camera controller 5 performs an operation to turn off the connectiontransistor, changes to the still-image class at step S111, performs an operation to turn on the connection transistor at step S112, and ends the operation flow.

The means for detecting the end of connection to cause the personal computer 20 to read data for recognition of a device other than a storage device and for automatically changing to cause the electronic still camera to perform as a device other than a storage device is accomplished by the camera controller 5 which detects connector-off and power-off by the user. Further, the CPU (with a built-in clock) in the camera controller 5 can work as timer, comparing, switching, and changing means. With these means, the camera controller 5 measures the time passed after the electronic still camera is connected as CD-ROM, checks whether the electronic still camera is connected to an OS that cannot support the USB connection, the automatic installation failed, or reconnection is not completed although installation is complete when the connection continues longer than the predetermined time period, automatically changes connections, and turns on and off the connection transistor.

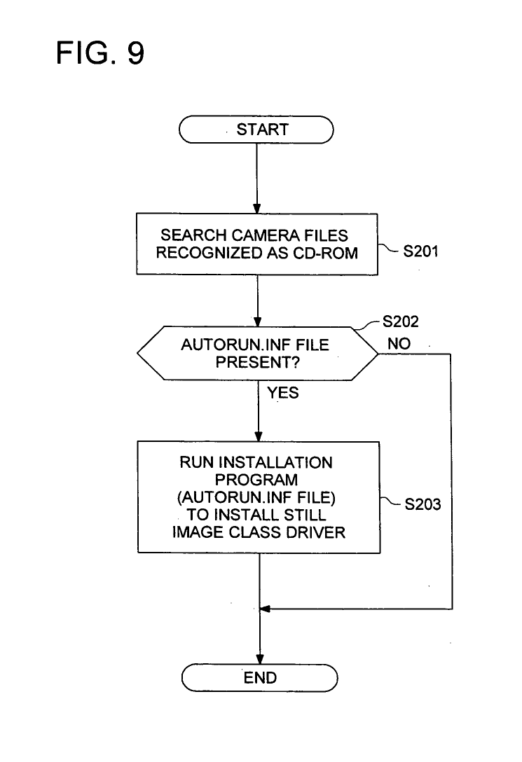

FIG. 9 shows an operational flow of the personal computer 20. At step S201, the personal computer 20 searches the first memory area of the electronic still camera, which is to be recognized as CD-ROM.

At step S202, the personal computer 20 checks whether the first memory area of the electronic still camera contains the “autorun.inf” file and ends the operation flow when finding no “autorun.inf” file. When finding the “autorun.inf” file, the personal computer executes the install program specified in the “autorun.inf” file at step S203 and installs the still-image class driver to the work memory of the personal computer 20. With this, the personal computer can read image data from the electronic still camera.

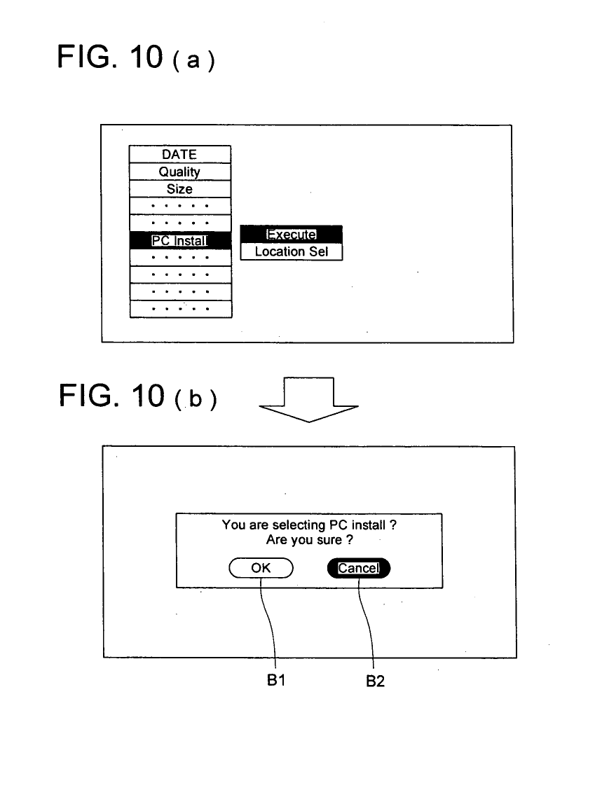

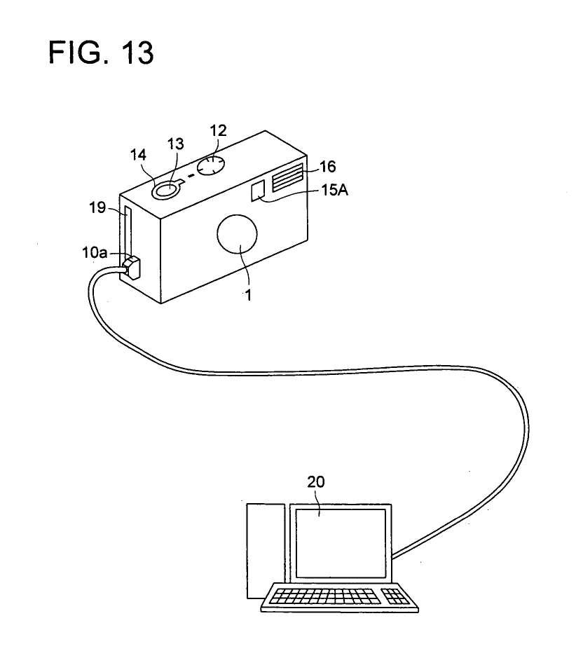

FIG. 10 shows sample LCD displays of the electronic still camera for setting a mode to install a still image device driver to a personal computer 20. The mode switch SW12 (shown in FIG. 1, FIG. 13) of the electronic still camera is used to select a setup mode and set an operation mode. When the user selects “PC Install” on the menu by the menu selection key, the “Execute” submenu appears. (shown in FIG. 10(a)) Select “Execute.” The Install mode is set and the electronic still camera can work as a storage device. When the user select “Location Set,” the user can set whether the personal computer 20 is allowed to access the first memory area as the storage area or the other area such as a memory card 8. When the user select “Execute” on the menu, a dialog box (shown in FIG. 10(b)) appears on-screen to ensure whether the user actually wants to change modes. The user clicks the OK button B1 in the dialog box to select installation to the personal computer or the Cancel button B2 to return to the menu screen (shown in FIG. 10(a)).

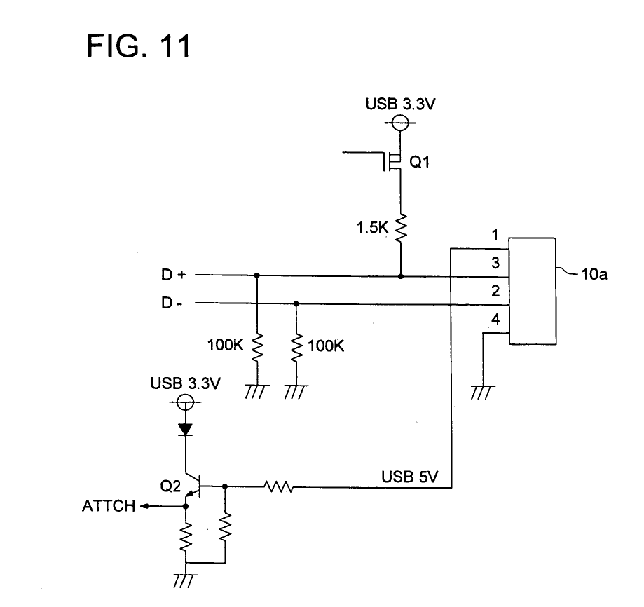

FIG. 11 is a circuit drawings of the USB interface connector 10 and its related parts. When the connector 10a is connected to a personal computer, the transistor Q2 turns on and activates a Connection Detected signal. When the transistor Q1 turns on, the D+ signal is pulled up and information of connection is delivered to the personal computer (as a host). When the transistor Q1 is turned off, the electric connection is canceled.

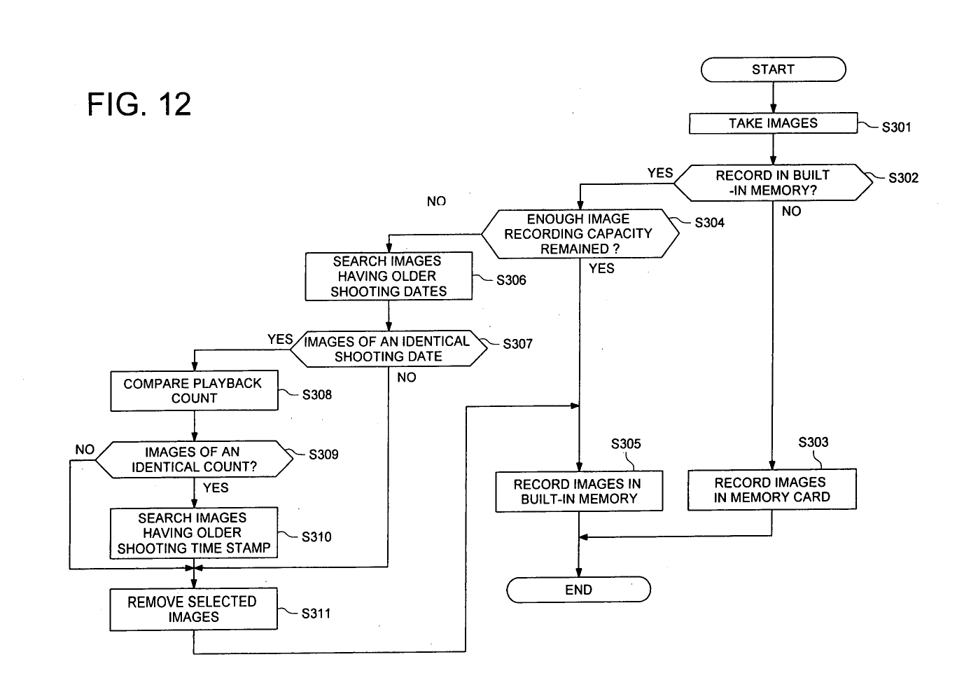

FIG. 12 is an operational flow of selecting images to be removed when the built-in image memory is full and removing the selected images. After taking a picture at step S301 of FIG. 12, the camera controller 5 checks whether the image data is to be recorded in the built-in memory at step S302. When judging that the image data should not be recorded in the built-in memory (flash memory ROM 9), the camera controller 5 saves the captured image data in memory card 8 at step 303.

When judging that the image data should be recorded in the built-in memory, the camera controller 5 as a detecting means checks whether the remaining storage area in the built-in memory (flash memory ROM 9) is more than a pre-determined value. When the remaining storage area is enough (more than a preset value), the camera controller 5 saves the captured image data in the built-in memory at step S305.

When the remaining storage area (flash memory ROM 9) is not enough (less than a pre-determined value), the camera controller 5 searches image data that has been stored in the built-in memory longest (or image data of the oldest shooting/storage date) at step S306. Further at step S307, the camera controller 5 as a erasing means checks whether there are two or more image data frames of the same shooting/storage date. When there is only one frame of the oldest date, the camera controller 5 selects it and erases it at step S311.

When there are two or more image data frames of the same shooting/storage date, the camera controller 5 as a counting means gets read-counts of the frames at step S308 and compares them by a pre-determined count at step S309. If their counts are different, the camera controller 5 selects and removes a image data frame of the less count value at step S311. If their counts are the same, the camera controller 5 selects the image data frames of the oldest shooting/storage time at step S310 and erases them at step S311. It is possible to set the Prohibit mode by a related menu button (not visible In the drawings) and to suppress automatic removal of image data of the oldest shooting/storage date or to output a reconfirmation message such as “Are you sure to delete?” before the automatic removal of image data and to remove the image data only when the user clicks the OK button. This can protect necessary image data from deletion.

FIG. 13 is a perspective view of an electronic still camera which is an embodiment of the present invention. The electronic still camera has a mode switch 12, a release button 13, and a power switch 14 on the top of the camera body, a lens assembly 1, a finder 15A, and a flash light 16 on the front of the camera body, and a slot 19 for memory card 8 (shown in FIG. 1) and a USB connector 10a (not shown in the drawings) for connection with the personal computer on the side of the camera body.

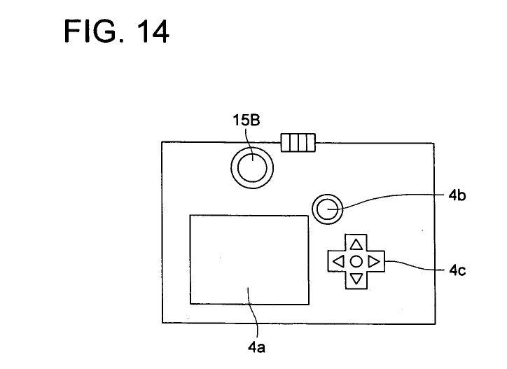

FIG. 14 is a rear view of an electronic still camera which is an embodiment of the present invention. The rear panel of the electronic still camera has a display screen 4a of the liquid-crystal display section 4 (shown in FIG. 1), a LCD display ON/OFF button 4b, menu selection keys 4c, and a finder 15B.

The latest-released general-purpose operating systems (OSs) have supported common storage device drivers by USB interface. However, in this configuration, image data in the electronic still camera as a storage device is treated only as files on a drive. Therefore, this configuration cannot use functions that allow the personal computer to control the electronic still camera directly, for example, by a TWAIN device driver, and a function that allows user to customize the camera operation. Further, it is not possible to transfer image data to the personal computer without storing image data in the memory card at the electronic still camera. Contrarily, by installing a device driver for a device other than a storage device as stated in this embodiment, the electronic still camera can handle captured image data and enable the personal computer to perform the above added functions.

With those and other objects in view, it is to be understood that the invention is not intended to be limited to the specific embodiments. Further it is understood that various changes and modifications, within the scope of the claims, may be resorted to without departing from the spirit of the invention.

The first embodiment of the present invention can provide a convenient electronic still camera even when storage capacity is increased. The second embodiment of the present invention can provide in-expensive electronic still camera with compact size and low power consumption.

Disclosed embodiment can be varied by a skilled person without varying from the spirit and scope of the invention.

1-15. (canceled)

16. An electronic still camera, comprising:
an interface for a personal computer;
a storage area for storing a program for a personal computer;
a means for making a personal computer recognize the camera as a storage device when the camera is connected to the personal computer via the interface;
a means for making the personal computer which recognized the camera as a storage device automatically access the storage area to run the program,
wherein the program makes the accessed personal computer recognize the camera as not a storage device.

17. An electronic still camera of claim 16, wherein the means for making a personal computer recognize the camera as a storage device makes the personal computer recognize the camera as a CD-ROM drive.

18. An electronic still camera of claim 16, wherein the storage area is a built-in memory.

19. An electronic still camera of claim 16, wherein the storage area is a memory card mounted on the electronic still camera.

20. An electronic still camera of claim 16, wherein the storage area is a non-volatile memory medium.

21. An electronic still camera of claim 16, further comprising:
a means for selectively allowing the personal computer which recognized the camera as a storage device to access the storage area to run the program.

22. An electronic still camera of claim 16, wherein the means for making a personal computer recognize the camera as a storage device comprises a first device ID code different from a second device ID code by which the program makes the accessed personal computer recognize the camera as not a storage device.

23. An electronic still camera of claim 16, further comprising:
a means for detecting detachment of camera-PC connection after the accessed personal computer recognize the camera as not a storage device;
a means for automatically making the camera act as not a storage device,
wherein the camera work as not a storage device when the camera is re-connected to the personal computer.

24. An electronic still camera of claim 16, further comprising:
a switching means for switching the connection of the interface on or off;
a timer means for measuring a connecting time of the personal computer's recognition of the camera as not a storage device;
a comparing means for comparing the connecting time with a predetermined time period;
a changing means for automatically making the camera act as not a storage device,
wherein when the comparing means detects that the connecting time exceeds the predetermined time period, the switching means switches the connection of the interface from on to off, the changing means makes the camera act as not a storage device, and then the switching means switches the connection of the interface from off to on.

25. An electronic still camera of claim 16, wherein the means for making the personal computer recognize the camera as a storage device makes the personal computer recognize the camera as a still image class device.
